(19) United States
(12) Patent Application Publication
(10) Pub. No.: US 2022/0055517 A1
(43) Pub. Date: Feb. 24, 2022

(54) METHOD AND APPARATUS FOR TRANSPORTING GOODS

(71) Applicant: Kirby Manufacturing, Inc., Merced, CA (US)

(72) Inventors: Paul L. Ardison, St. Peter, MN (US); Richard M. Kirby, Merced, CA (US)

(73) Assignee: Kirby Manufacturing, Inc., Merced, CA (US)

(21) Appl. No.: 17/308,419

(22) Filed: May 5, 2021

Related U.S. Application Data
(60) Provisional application No. 63/069,350, filed on Aug. 24, 2020.

(51) Int. Cl. B60P 1/38; A01K 5/02; G05D 1/02

(52) U.S. Cl. CPC B60P 1/38; A01K 5/0208; A01K 5/01; G05D 1/0223; G05D 1/0225

(57) ABSTRACT

An autonomous vehicle for transporting and delivering livestock feed to a feed bunk in a feedlot without human intervention. The vehicle includes a chassis having a translation assembly for moving the vehicle across a surface, a delivery box operably engaged with the chassis and defining a chamber for carrying the feed. A load-dispensing assembly and a load-advancement mechanism are provided on the delivery box. Actuating the load-advancement mechanism moves the livestock feed toward the load-dispensing assembly. A control assembly is provided with programming configured to autonomously control movement of the vehicle along a predetermined pathway in the feedlot, autonomously control the load-advancement mechanism and load-dispensing assembly to deliver feed from the delivery box into a feed bunk at a preset location along the pathway, and/or control the ground speed of the vehicle so that an exact weight of feed is delivered per linear foot traveled by the vehicle.

### CROSS-REFERENCE TO RELATED APPLICATIONS

This application claims the benefit of U.S. Provisional Patent Application Ser. No. 63/069,350, filed Aug. 24, 2020, the entire disclosure of which is incorporated herein by reference.

### TECHNICAL FIELD

This disclosure is directed to vehicles and methods for transporting goods. More particularly, this disclosure relates to autonomous vehicles, i.e., vehicles that are operated independently of human interaction therewith. Specifically, the disclosure relates to an autonomous vehicle for transporting livestock feed and to a method of delivering the livestock feed to a feed bunk using the autonomous vehicle.

### BACKGROUND

### Background Information

In large farming operations, livestock, such as cattle, may be moved from farms where they were grazing in pastures to feedlots where they are readied for slaughter. Over the course of several months, the livestock in the feedlots are given sufficient feed on a regular schedule to enable them to rapidly build muscle and put on weight. The ration provided to each animal is designed to be highly nutritious and readily digested. In addition to providing the animals with the correct food, each animal is fed three times a day. With tens of thousands of animals in a single feedlot, providing each animal with the right amount of food at the right times of time is a challenging and time consuming task. Dairy cattle are fed in a similar manner.

The ration comprises various combinations of commodities including but not limited to silage, corn, barley, oats, sorghum, soybeans, canola corn, wheat, Distillers Dried Grains Plus Solubles (DDGS), vitamins, minerals and other supplements and additives. The various commodities are provided in predetermined amounts to the ration provided to animals at different stages of growth. The desired commodities are loaded into a mixing station where they are mixed together to make a substantially uniform mixture. The mixed feed is subsequently loaded into a feed delivery truck. The animals are kept in pens that typically have a feed bunk running down one side of the pen. Once the feed delivery truck is loaded, the driver will drive the feed delivery truck down a feed alley adjacent the feed bunk. The feed delivery truck is provided with a conveyor that progressively moves the feed forwardly within the truck bed toward a front end of the bed. A rotating auger and rotating finger rollers proximate the front end of the bed move the feed onto a second conveyor that then moves the feed toward an opening in a side wall of the truck. Driving the truck slowly alongside the feed bunk, the driver will raise a door in the truck's side wall to allow feed to drop off the second conveyor and onto a chute extending downwardly and outwardly from the truck. The feed slides down the chutes and into the feed bunk. The driver determines the speed at which the truck travels alongside the feed bunk and also determines how high to raise the door in the truck side wall. The driver therefore personally controls the quantity of feed that is delivered into the feed bunk by selecting the speed of the truck and the size of the door opening. Because the driver is in control of the vehicle and the delivery of feed therefrom, not all parts of the feed bunk may the same quantity of ration delivered thereto. The more experienced the driver, the more uniform the delivery of the ration may be. Variations in the quantity of ration delivered to different parts of the food bunk can affect the quantity of food that any particular animal receives and this in turn produces less predictable muscle and weight gain across the herd and, in the case of dairy herd, the quality and quantity of the milk production There may also be consequences to the overall health of the animals.

As mentioned above, because of the number of animals that have to be fed multiple times a day, seven days a week, month after month, the number of man hours expended on this task annually is quite substantial and contributes greatly to the cost of raising each animal.

### SUMMARY

The present disclosure relates to an autonomous vehicle for delivering feed to animals in a feedlot or similar situation. The autonomous vehicle transports and delivers the livestock feed to a feed bunk in a feedlot without human intervention. The autonomous vehicle includes a chassis having a translation assembly suitable for moving the vehicle across a surface and a delivery box operably engaged with the chassis. The delivery box defines a chamber therein and the load of livestock feed is carried in the chamber. A load-dispensing assembly and a load-advancement mechanism are provided on the delivery box. The load-advancement mechanism is actuated to move the livestock feed toward the load-dispensing assembly. A control assembly is provided with programming configured to autonomously control movement of the vehicle along a predetermined pathway in the feedlot. The programming is further configured to autonomously control the load-advancement mechanism, load-dispensing assembly, and a ground speed of the autonomous vehicle to deliver livestock feed from the delivery box and into a feed bunk at a preset location along the pathway and at a uniform flow rate. The programming may control the ground speed of the vehicle in such a way that a substantially exact weight of feed is delivered per linear foot traveled by the vehicle at the preset location.

In one aspect, an exemplary embodiment of the present disclosure may provide an autonomous vehicle for transporting and delivering a load comprising a chassis having a translation assembly adapted to move the chassis across a surface; a delivery box operably engaged with the chassis; said delivery box being adapted to carry the load; a load-dispensing assembly provided on the delivery box; a load-advancement mechanism provided on the delivery box; said load-advancement mechanism being adapted to move the load toward the load-dispensing assembly; a control assembly; programming provided in the control assembly, said programming configured to autonomously control movement of the chassis and the delivery box along a predetermined pathway; said programming further configured to autonomously control the load-advancement mechanism and the load-dispensing assembly to deliver the load from the delivery box at a preset location along the pathway.

In one embodiment, the programming may be further configured to autonomously deliver the load from the delivery box at a substantially uniform flow rate. In one embodiment, the programming may be further configured to control a ground speed of the autonomous vehicle as the autonomous vehicle travels along the pathway. In one embodiment, the programming may be further configured to dispense the load from the delivery box at a substantially uniform flow rate that is correlated to the ground speed. In one embodiment, a scale assembly may be interposed between the delivery box and the chassis and operably linked to the control assembly; wherein the scale assembly substantially continuously weighs the delivery box and the load carried therein. In one embodiment, a ground speed of the autonomous vehicle traveling along the pathway may be correlated with a combined weight of the delivery box and the load so that a substantially exact weight of the load is delivered per linear foot traveled by the autonomous vehicle at the preset location. In one embodiment, one or more batteries may be provided on the chassis to power the autonomous vehicle. In one embodiment, one of more of a camera, a sensor, and a laser operably may be engaged with the control assembly and configured to gather data about an environment in which the autonomous vehicle operates. In one embodiment, at least one bumper may be provided on the chassis. In one embodiment, at least the chassis having the translation assembly, the delivery box, the load-dispensing assembly, and the load-advancement mechanism are provided on a truck.

In another aspect, an exemplary embodiment of the present disclosure may provide in combination a load of livestock feed; and an autonomous vehicle for transporting and delivering the load of livestock feed to a feed bunk in a feedlot without operator intervention; wherein the autonomous vehicle comprises a chassis having a translation assembly adapted to move the autonomous vehicle across a surface; a delivery box operably engaged with the chassis; said delivery box defining a chamber, wherein the load of livestock feed is carried in the chamber; a load-dispensing assembly provided on the delivery box; a load-advancement mechanism provided on the delivery box; said load-advancement mechanism being actuated to move the load of livestock feed toward the load-dispensing assembly; a control assembly; and programming provided in the control assembly, said programming configured to autonomously control movement of the chassis and delivery box along a predetermined pathway in the feedlot; said programming further configured to autonomously control the load-advancement mechanism and the load-dispensing assembly to deliver the load of livestock feed from the delivery box and into a feed bunk at a preset location along the pathway.

In one embodiment, the programming may further be configured to autonomously deliver the load of livestock feed from the delivery box at a substantially uniform flow rate. In one embodiment, the programming may further be configured to control a ground speed of the autonomous vehicle as the autonomous vehicle travels along the pathway. In one embodiment, the programming may further be configured to dispense the load of livestock feed from the delivery box at a substantially uniform flow rate that is correlated to the ground speed. In one embodiment, the programming may include an automated feed distribution algorithm that determines a precise amount of mixed livestock feed to deliver from the autonomous vehicle to the feed bunk in the feedlot as the load of livestock feed. In one embodiment, the programming may include an automated feed distribution algorithm that controls a ground speed of the autonomous vehicle so that an exact weight of feed is delivered per linear foot traveled by the autonomous vehicle at the preset location. In one embodiment, the autonomous vehicle may be a truck.

In another aspect, an exemplary embodiment of the present disclosure may provide a method of delivering feed to livestock comprising loading livestock feed into a chamber defined by a delivery box of an autonomous vehicle; actuating a control assembly on the autonomous vehicle; actuating a motor provided on the autonomous vehicle with programming provided in the control assembly; moving the autonomous vehicle along a pathway programmed into the control assembly; actuating a load-advancement mechanism provided in the delivery box with the programming of the control assembly; advancing the livestock feed towards a load-delivery assembly provided on the delivery box; actuating the load-delivery assembly with the programming provided in the control assembly; and delivering the livestock feed from the chamber to a location outside of the delivery box chamber.

In one embodiment, at least the steps of actuating the motor through to delivering the livestock feed may be accomplished independent of human interaction with the autonomous vehicle. In one embodiment, the method may include providing at least the delivery box, the motor, the load-advancement mechanism, and the load-delivery assembly on a truck. In one embodiment, the autonomous vehicle may be guided by using a Global Positioning System (GPS) and/or 3-point triangulation, laser guidance, a pre-selected path that is programmed and saved in the controller memory, or any other means of guidance.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic top plan view of a system for transporting livestock feed from a mixing station to a feed bunk by utilizing an autonomous delivery vehicle in accordance with the present disclosure;

FIG. 2 is a rear isometric perspective view of an autonomous delivery vehicle in accordance with the present disclosure;

FIG. 3 is an exploded partial isometric perspective view of the autonomous delivery vehicle of FIG. 2;

FIG. 4 is a top plan view of the vehicle delivery box of the autonomous delivery vehicle;

FIG. 5 is a top plan view of a first embodiment of a chassis of the autonomous delivery vehicle with the crossbeams of the frame removed for clarity of illustration;

FIG. 6 is an enlarged left side elevation view of the rear end of the autonomous delivery vehicle showing the engagement of the feed delivery box and chassis;

FIG. 7A is a cross-section through line 7A-7A of FIG. 6;

FIG. 7B is a cross-section through line 7B-7B of FIG. 6;

FIG. 8 is a longitudinal cross-section of the autonomous delivery vehicle taken along line 8-8 of FIG. 4;

FIG. 9 is a longitudinal cross-section similar to FIG. 8 showing an exemplary electrical connectivity between the vehicle delivery box and the chassis of the autonomous delivery vehicle;

FIG. 10 is an isometric perspective view of a second embodiment of the chassis that may form a part of the autonomous delivery vehicle;

FIG. 11A is a top plan view of the second embodiment chassis of the autonomous delivery vehicle with the crossbeams of the frame removed for clarity of illustration;

FIG. 11B is a top plan view of the second embodiment chassis illustrating the 4-wheel steering capability of the chassis;

FIG. 12 is a cross-section of the second embodiment chassis taken along line 12-12 of FIG. 11A.

Similar numbers refer to similar parts throughout the drawings.

### DETAILED DESCRIPTION

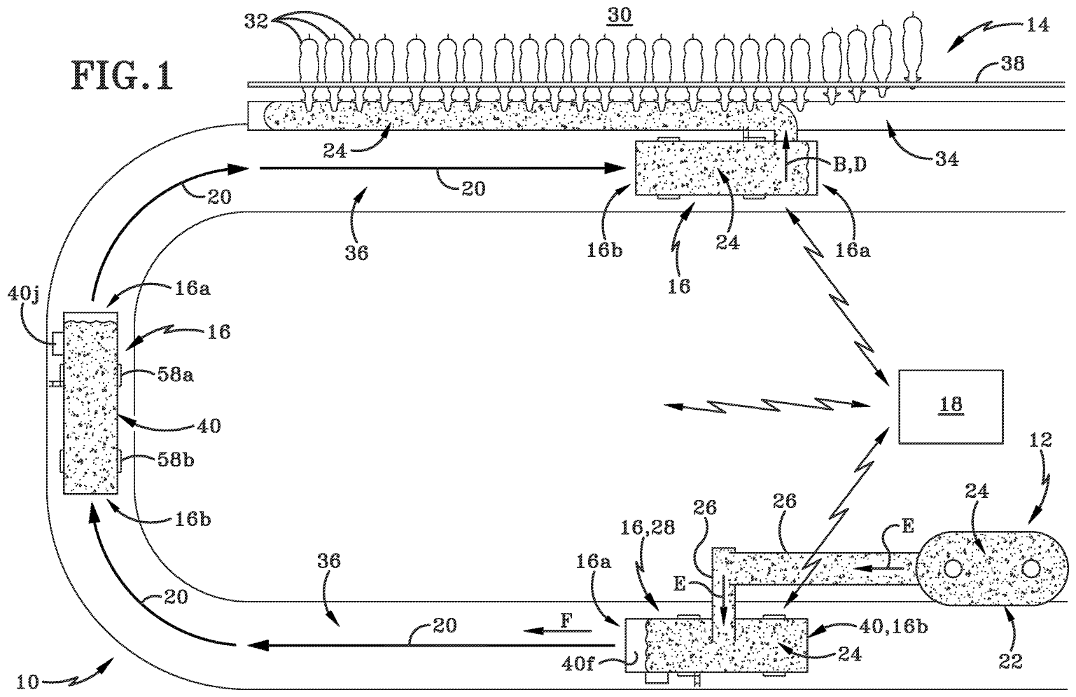

FIG. 1 is a schematic view of an exemplary system for delivering feed to livestock utilizing an autonomous delivery vehicle in accordance with an aspect of the present disclosure, generally indicated at 10. System 10 is illustrated in FIG. 1 in the context of a feedlot for livestock such as cattle. It will be understood, however, that system 10 may be utilized to provide feed to any other livestock in similar settings or in other appropriate settings. In one embodiment, the exemplary system could be utilized to provide feed to dairy cattle.

As illustrated, system 10, includes a mixing station 12, a feedlot 14, one or more autonomous, guided delivery vehicles in accordance with the present disclosure, generally indicated at 16, and a controller 18. The autonomous, guided delivery vehicle(s) 16 will be referred to hereinafter as “vehicle 16” or “vehicles 16”. The vehicles 16 are referred to as being autonomous, meaning they are unmanned, i.e., there is no driver present in the vehicle 16 and the vehicle is fully operational without operator interaction. The vehicles 16 are referred to as guided vehicles because they are controlled and guided along a path of travel 20 (FIG. 1) by programming uploaded into a processor provided in the vehicle 16 itself or in the controller 18 which is located remote from vehicle 16. Vehicles 16 preferably are electric vehicles that are battery powered. It will be understood that in other embodiments, vehicles 16 may be powered by an internal combustion engine.

System 10 as illustrated includes three autonomous delivery vehicles 16 but it will be understood that system 10 may include a single vehicle 16, two vehicles 16, or three or more vehicles 16. Vehicles 16 are provided to move along a planned, predetermined pathway 20 through system 10 from mixing station 12 where vehicle 16 is loaded with feed, to the feedlot 14 where the vehicle 16 delivers the feed, and back to mixing station 12 to be reloaded. The cycle may be repeated at intervals over the course of the day as necessary. It will be understood that pathway 20 is illustrated as a single pathway but in reality multiple pathways may be provided in system 10 and the vehicle 16 will sequentially move through the multiple pathways and be reloaded with feed from the mixing station 12 when necessary.

Mixing station 12 is utilized to mix a predetermined variety of different feedstuffs that may include but are not limited to silage, corn, barley, oats, sorghum, soybeans, canola, Distillers Dried Grains Plus Solubles (DDGS), and various supplements and additives. Any suitable feedstuff may be included in the daily ratio. Mixing station 12 includes a mixer 22 of any desired type such as a stationary or mobile Total Mixed Ration (TMR) mixer. Mixer 22 is not part of vehicle 16 but is, instead, a separate, stand-alone piece of equipment, preferably a stationary piece of equipment. Mixer 22 may be a horizontal TMR mixer or a vertical TMR mixer and may include one or more augers to thoroughly mix together the feedstuffs loaded into the mixer 22 to create a generally uniform mixed feed 24. The mixer 22 illustrated in FIG. 1 is representative of a twin auger vertical TMR mixer. Although not illustrated herein, it will be understood that a front end loader or any other suitable piece of equipment may be used to load pre-specified quantities of the desired feedstuffs into the mixer 22. Mixer 22 is actuated and the auger(s) therein will progressively and thoroughly mix the feedstuffs until the desired feed mixture 24 is produced. A conveyor 26 is illustrated as being operatively engaged with the mixer 22 and is utilized to convey the mixed feed 24 from the mixer 22 to a loading station 28. Each vehicle 16 will position itself correctly relative to the loading station 28 so that a preset quantity of mixed feed 24 will be loaded into the vehicle 16. It will be understood that the mixer 22, conveyor 26, and loading station 28 may be of any suitable construction and configuration that mixes and delivers a desired feed ration to the vehicle 16. It is contemplated that all the operational aspects of the mixer 22, conveyor 26, and the loading stations 28 will be fully automated and will work in conjunction with vehicle 16.

Feedlot 14 includes a feeding pen 30 sized to hold a large number of cattle 32. A feed bunk 34 extends along one side of feeding pen 30 and is located adjacent a feed alley 36. It will be understood that any configuration of feed bunk 34 is contemplated to be part of feedlot 14. The feed bunk 34 may not be an actual physical structure that runs along the side of the feed alley 36 but may simply be a strip of land along the side of the feed alley 36. A feed fence barrier 38 separates the feeding pen 30 from the feed bunk 34. The feed fence barrier 38 partially restrains the cattle 32 from moving into the feed bunk 34. The barrier 38 allows the cattle 32 to simple moves their heads and necks through the barrier 38 to a sufficient degree that they are able to eat feed from the feed bunk 34.

The mixing station 12 with mixer 22, conveyor 26, and loading station 28, as well as the feedlot 14 with feeding pen 30, feed bunk 34, feed alley 36, and feed fence barrier 38 are all well known in the art and therefore will not be described in any additional detail herein.

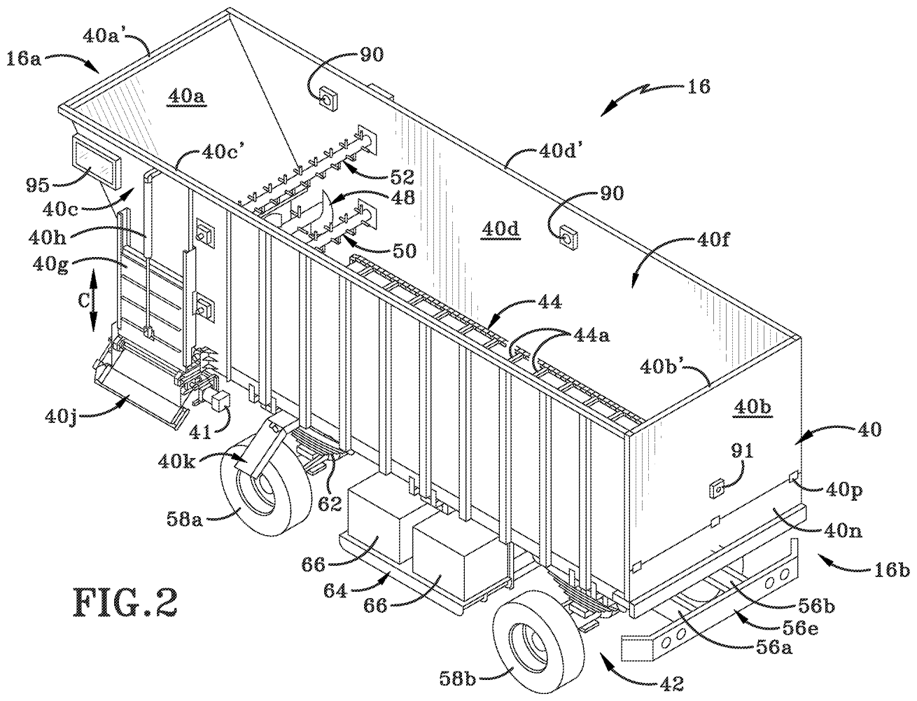

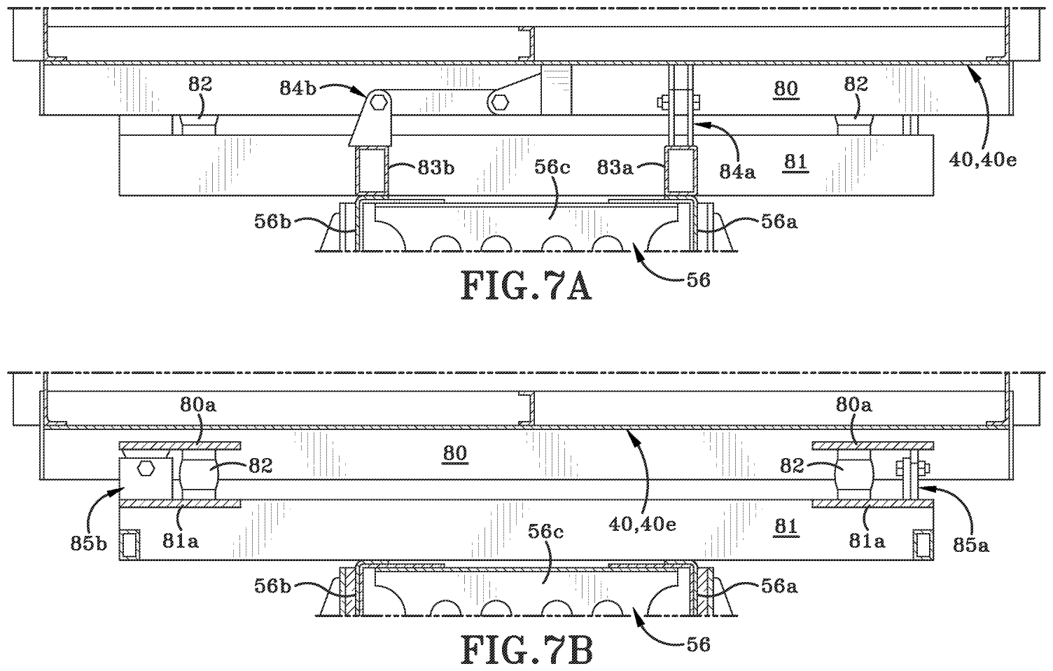

FIGS. 2 through 9 show an exemplary autonomous delivery vehicle 16 in accordance with an aspect of the present disclosure. Vehicle 16 has a front end (or leading end) 16a and a rear end (or trailing end) 16b. It will be understood that vehicle 16 is capable of being maneuvered in much the same way as any automobile or truck. The front end 16a is described as the leading end of the vehicle 16 simply by virtue of the specific configuration of the vehicle 16 illustrated in the figures where the leading end 16a moves around the pathway 20 before the trailing end 16b. This orientation of vehicle 16 requires that feed for the livestock 32 is delivered out of a doorway defined in a left side wall of the vehicle 16 and into a feed bunk 34 that is on the left side of the vehicle. Obviously, in other embodiments, the doorway may be provided in a right side wall of the vehicle 16.

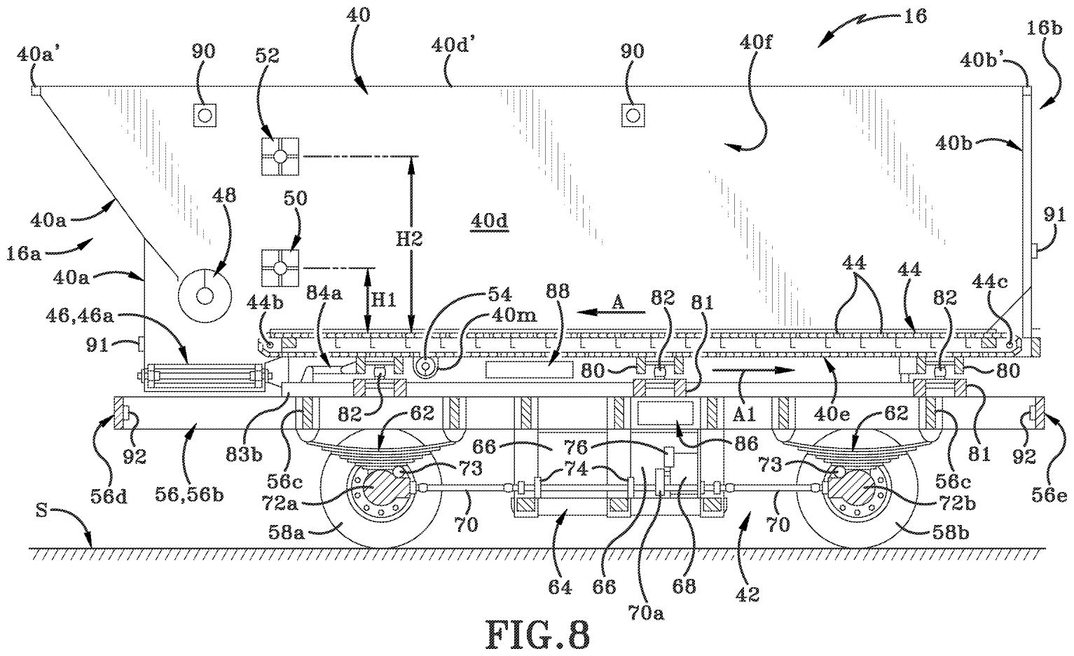

Vehicle 16 comprises a feed delivery box 40 and a chassis 42 that are operatively engaged with each other. Chassis 42 comprises a heavy-duty Gross Vehicle Weight (GVW) mobile platform that supports and moves feed delivery box 40 along a surface “S” (FIG. 8).

Feed delivery box 40 includes a front wall 40a, a rear wall 40b, a left side wall 40c, a right side wall 40d, and a bottom wall 40e (FIG. 8). An interior chamber 40f is bounded and defined by front wall 40a, rear wall 40b, left side wall 40c, right side wall 40d, and bottom wall 40e. Front and rear walls 40a, 40b define a longitudinal direction therebetween; left and right side walls 40c, 40d define a lateral direction therebetween. Feed delivery box 40 has a longitudinal axis “Y” that extends from front wall 40a to rear wall 40b. Feed delivery box 40 also has a lateral axis “X” that extends from left side wall 40c to right side wall 40d and is oriented at right angles to longitudinal axis “Y”. As shown in FIG. 2, each of the front, rear, left and right side walls 40a, 40b, 40c, and 40d originates at bottom wall 40e and extends upwardly to an upper edge 40a′, 40b′, 40c′ and 40d′, respectively. The upper edge 40a′, 40b′, 40c′, 40d′ bounds and defines an opening to interior chamber 40f and the feed delivery box 40 is loaded with feed through this opening. A plane passing through the upper edge 40a′, 40b′, 40c′, 40d′ and the bottom wall 40e define a vertical direction therebetween and the height of the side walls 40c, 40d is measured between bottom wall 40e and the upper edge.

At least a portion of front wall 40a is oriented at an angle relative to bottom wall 40e, as shown in FIG. 8. The angled portion of front wall 40a extends upwardly and forwardly away from a front end of bottom wall 40e. When feed is loaded into interior chamber 40f, they are advanced forwardly toward front end 16a of vehicle 16. The slope on the angled portion of front wall 40a ensures that if the feed start rising up the side walls 40c, 40d as they move forwardly within chamber 40f, that upward movement can at least be partially compensated for by the increased surface area of the front wall 40a, and the feed will tend to ride up that slope. This arrangement can help to ensure that feed does not tend to drop over the upper edge 40c′, 40d′ of left and right side walls 40c, 40d.

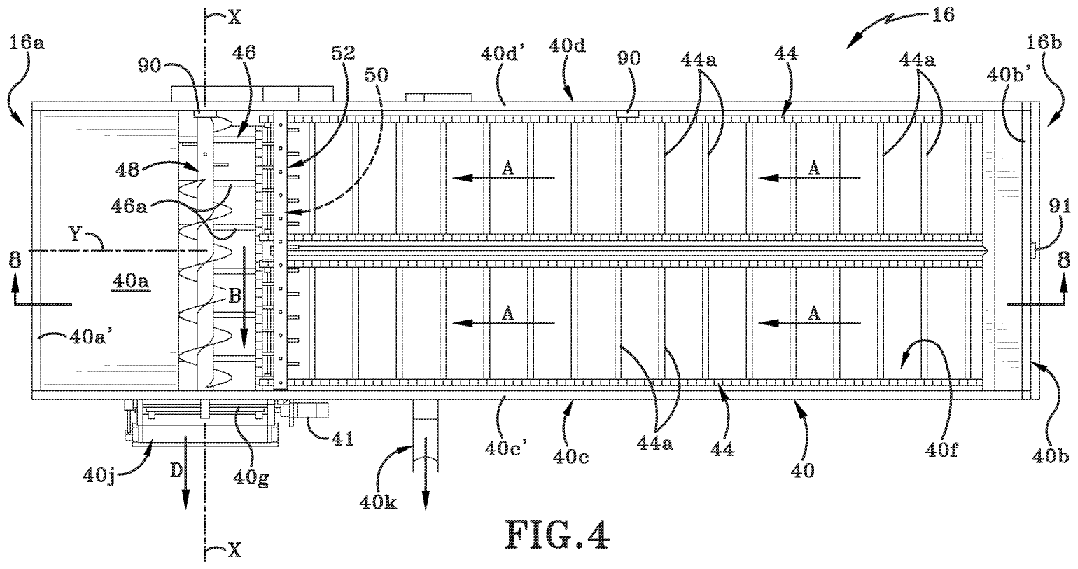

Vehicle 16 is provided with a load-advancement mechanism that is used to move livestock feed within the chamber 40f of delivery box 40. In particular, the load-advancement mechanism is used to move the livestock feed within the chamber 40f from the location where the feed was placed into the chamber by the loading station 26 to a load-delivery assembly on delivery box 40, as will be described hereafter. The load-advancement mechanism includes a primary conveyor 44 provided proximate bottom wall 40e of vehicle 16. It will be understood that primary conveyor 44 is operably engaged with a motor (not shown) that drives the movement thereof. Primary conveyor 44 is operable to advance feed loaded into interior chamber 40f in a direction moving from rear wall 40b of delivery box 40 towards front wall 40a thereof. This direction of motion is indicated by the arrows “A” in FIG. 4 and runs substantially parallel to the longitudinal axis “Y” of feed delivery box 40. Primary conveyor 44 extends from a rear end located a short distance forwardly of 40b to a front end located a distance rearwardly of the angled portion of front wall 40a. Primary conveyor 44 is utilized to move feed longitudinally forwardly within chamber 40f towards front wall 40a. One suitable type of primary conveyor 44 is illustrated in the attached figures and that is a drag chain conveyor. Drag chain conveyor 44 includes a plurality of drag bars 44a that are configured to contact and move the feed loaded into chamber 40f. Drag chain conveyor 44 is configured to rotate around two longitudinally spaced-apart pivots, namely front pivot 44b and rear pivot 44c. Although not illustrated herein, it will be understood that the rotational motion of primary conveyor 44 is driven by a motor. It will further be understood that any other type of conveyor may be utilized in vehicle 16 in the place of the drag chain conveyor illustrated and described herein.

The load-advancement mechanism includes a secondary conveyor 46 (FIG. 4) provided forwardly of the front end of the primary conveyor 44. Secondary conveyor 46 is operatively engaged with a motor 41 that drives the movement thereof. As best seen in FIG. 8, primary conveyor 44 slightly overlaps a rear edge of secondary conveyor 46. Additionally, primary conveyor 44 is positioned slightly further away from bottom wall 40e of delivery box 40 than is secondary conveyor 46. As a result, feed carried on primary conveyor 44 will drop onto secondary conveyor 46 when they reach the front end of primary conveyor 44. Secondary conveyor 46 is oriented parallel to the lateral axis “X” of feed delivery box 40 and at right angles to primary conveyor 44. Secondary conveyor 46 originates proximate right side wall 40d and extends to proximate left side wall 40c. Although not illustrated herein, it will be understood that secondary conveyor 46 rotates about two laterally spaced-apart pivots and is driven by a motor. One suitable type of secondary conveyor 46 is a drag chain conveyor that includes a plurality of drag bars 46a. Drag bars 46a capture and move feed laterally towards left side wall 40c as secondary conveyor 46 is rotated. It will be understood that any other type of conveyor may be utilized in vehicle 16 other than the drag chain conveyor 46 illustrated and described herein. Secondary conveyor 46 rotates in such a way that the movement of the feed is in the direction indicated in FIG. 4 by the arrow “B”. In particular, primary conveyor 44 moves feed longitudinally forwardly within chamber 40f towards front wall 40a and the load of feed carried by primary conveyor 44 is gradually deposited onto secondary conveyor 46.

The load-delivery assembly provided on vehicle 16 includes an opening defined in left side wall 40c of delivery box 40 and a door 40g operatively mounted on left side wall 40c to selectively close off the opening or reveal part or all of the opening. The opening in left side wall 40c is laterally aligned with secondary conveyor 46. As secondary conveyor 46 is rotated, the feed thereon is progressively moved towards the opening in left side wall 40c.

The load-delivery assembly further includes a drive mechanism 40h operatively engaged with door 40g and actuated to selectively raise or lower door 40g as is indicated by the arrow “C” in FIG. 2. The drive mechanism 40h as illustrated includes a cylinder and a piston that is driven to selectively raise or lower the door 40g.

The load-delivery assembly further includes a primary chute 40j extending downwardly and forwardly from left side wall 40c and in lateral alignment with the opening, door 40g, and secondary conveyor 46. Drive mechanism 40h is actuated to selectively raise or lower door 40g to control a size of the opening through which feed may be delivered by secondary conveyor 46 to primary chute 40j. The larger the opening created by lifting the door 40g upwardly, the greater the quantity of feed dropped down the chute 40j. The smaller the opening created by lowering the door 40g, the smaller the quantity of feed dropped down the chute 40j. When it is desired that no feed be dropped at any particular time, the door 40g is moved to its lowermost position such that all of the opening defined in the left side wall 40c is closed off.

In order to assist with moving feed within the chamber 40f of delivery box 40, the load-advancement mechanism further includes an auger 48 and a pair of finger rollers 50, 52 mounted transversely between left and right side walls 40c, 40d. As shown in FIG. 8, auger 48 and finger rollers 50, 52 are located towards front end 16a of delivery box 40. Auger 48 is located a distance vertically above secondary conveyor 46 and is generally centrally located with respect to a front edge and rear edge of the secondary conveyor 46. Auger 48 includes a shaft with a plurality of flights radiating outwardly therefrom. The auger's shaft is oriented parallel to the lateral axis “X”. It will be understood that each of the auger 48 and finger rollers 50, 52 is operably engaged with a motor (not identified herein) which drives the rotation thereof. Auger 48 is rotatable about the shaft thereof and in a direction that will cause feed in chamber 40f to be moved towards right side wall 40d.

Finger rollers 50, 52 are located a distance rearwardly of auger 48 (FIG. 8). Finger rollers 50, 52 are vertically aligned with one another and are spaced a distance vertically apart from one another. Finger roller 50 is located a first height “H1” above an upper surface of primary conveyor 44 and finger roller 52 is located a second height “H2” above the upper surface of primary conveyor 44, with the second height “H2” being greater than the first height “H1”. Finger roller 50 is located a distance vertically above but rearwardly from auger 48. Furthermore, finger rollers 50, 52 are generally vertically aligned with the front end of the primary conveyor 44. Each finger roller 50, 52 includes a shaft with a plurality of fingers radiating outwardly therefrom. The shafts of the finger rollers 50, 52 are both oriented parallel to the lateral axis “X” of vehicle 16. The direction of rotation of finger rollers 50, 52 is such that feed located within chamber 40f tend to be moved forwardly towards front wall 40a.

Feed is therefore moved longitudinally forwardly in the chamber 40f by primary conveyor 44 toward the rotating auger 48 and finger rollers 50, 52. This longitudinal motion is indicated by the arrow “A” (FIG. 4). Feed proximate the front end 16a of vehicle 16 are moved laterally in the direction indicated by arrow “B”, towards the opening in left side wall 40c. If the door 40g has been raised to a sufficient degree in the direction of arrow “C” (FIG. 2) that at least a portion of the opening is opened to a sufficient degree that there is fluid communication between the interior chamber 40f and the environment surrounding delivery box 40, feed is conveyed by secondary conveyor 46 out of chamber 40f and onto chute 40j. The feed then slides down chute 40j in the direction indicated by arrow “D” (FIG. 4). As the vehicle 16 moves down the feed alley 36 (FIG. 1), the feed sliding down chute 40j drop into the feed bunk 34. Cattle 32 can then reach through the fence barrier 38 and eat the feed in the feed bunk 34.

Returning to FIGS. 2, 4, and 8, it can be seen that a secondary chute 40k extends downwardly and outwardly from left side wall 40c a distance rearwardly away from primary chute 40j. Secondary chute 40k is an extension of a U-shaped channel 40m (FIG. 8) provided on vehicle box 40. Channel 40m is located beneath the lowermost region of primary conveyor 44, in particular, beneath a region of the conveyor 44 that travels in a direction “A1” moving away from front wall 40a and towards rear wall 40b. Channel 40m extends transversely across substantially the entire width of delivery box (i.e., from right side 40d to left side 40c) and is laterally aligned with secondary chute 40j. Channel 40m is oriented parallel to transverse axis “X”. A secondary auger 54 is mounted for rotation with channel 40m. The secondary chute 40k, channel 40m and secondary auger 54 form part of the load-delivery assembly provided on vehicle 16. It will be understood that secondary auger 54 is operably engaged with a motor (not identified herein) which drives the rotation of secondary auger 54. When the primary conveyor 44 moves feed forwardly in the direction of arrow “A” and onto the secondary conveyor 46, the conveyor 44 changes direction about front pivot 44b, and travels back towards rear wall 40b underneath the portion of the conveyor 44 moving the direction “A”. Some feed may become trapped by the conveyor 44 as it rotates about front pivot 44b and travel rearwardly in the direction indicated by arrow “A1”. Such trapped feed will tend to drop into channel 40m as the conveyor 44 passes over channel 40m. Secondary auger 54 rotates about a shaft that extends parallel to transverse axis “X” and moves the feed in the channel 40m towards left side wall 40c and into secondary chute 40k. The feed will slide down secondary chute 40k and be dropped into feed bunk 34 a distance rearwardly of the feed sliding down primary chute 40j.

FIG. 2, shows that at least one door 40n is provided as part of rear wall 40b. Door 40n is operatively engaged with rear wall 40b via hinges 40p and is able to be selectively pivoted about the hinges into an open position or a closed position. When door 40n is moved to the open position, an operator is able to reach through an opening defined in rear wall 40b and gain access to a rear end of primary conveyor 44 and any feed thereon. The operator is able to remove clear blockages in the feed conveying system through the opening in rear wall 40b. When such blockages have been cleared, door 40n may be moved back to a closed position to close off access to the opening in rear wall 40b. The door 40h is also used to adjust the floor drag chains 44.

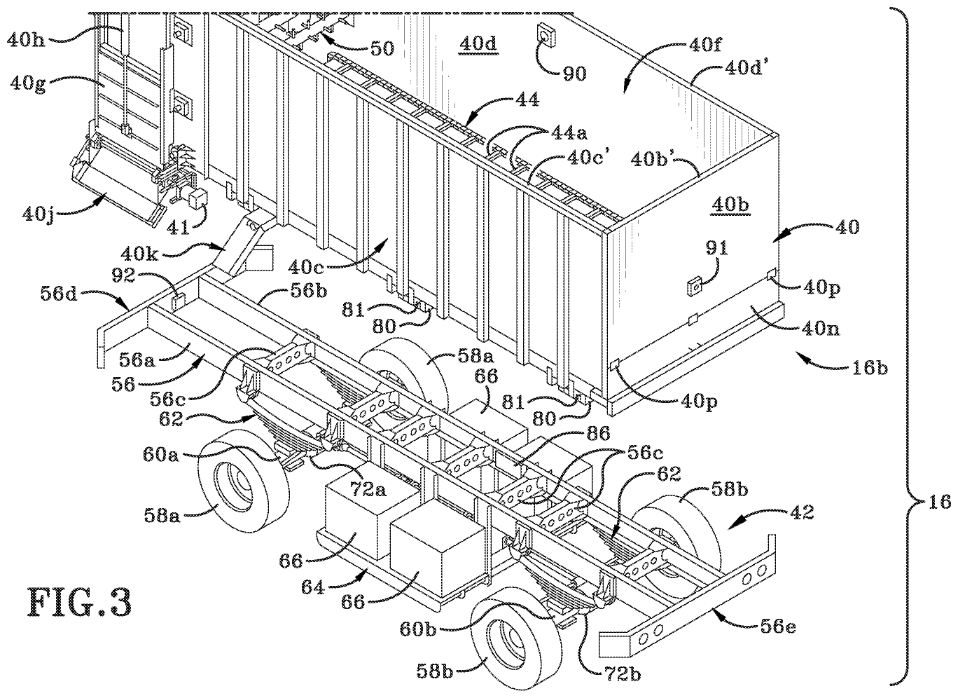

Referring to FIG. 3, chassis 42 comprises a frame 56 having at least a pair of laterally spaced apart support beams 56a, 56b and a plurality of longitudinally spaced-apart crossbeams 56c. It will be understood that 56a, 56b may be any suitable desired length, and crossbeams 56c may be of any suitable desired width. It will be understood that other components may be utilized in frame 56 in addition to support beams 56a, 56b, and crossbeams 56c. The various components of frame 56, including support beams 56a, 56b, and crossbeams 56c, may be joined together by any suitable means such as by use of HUCK® fasteners and/or welding. (HUCK® is a registered trademark of ARCONIC INC. of Pittsburgh Pa., USA). A pair of front wheels 58a and a pair of rear wheels 58b are illustrated as being operatively engaged with support beams 56a, 56b of frame 56 via axles 60a, 60b, respectively, and a leaf spring suspension 62.

It will be understood that if the frame 56 is of a longer length, at least one additional pair of wheels may be engaged with frame 56 via an associated axle and rigid axle mount assemblies. The particular arrangement of the chassis 42 is such that vehicle 16 is capable of making relatively tight turns as the vehicle maneuvers around system 10. Frame includes a front bumper 56d and a rear bumper 56e that are each operatively engaged with support beams 56a, 56b. Bumpers 56d, 56e are oriented transversely relative to support beams 56a, 56b.

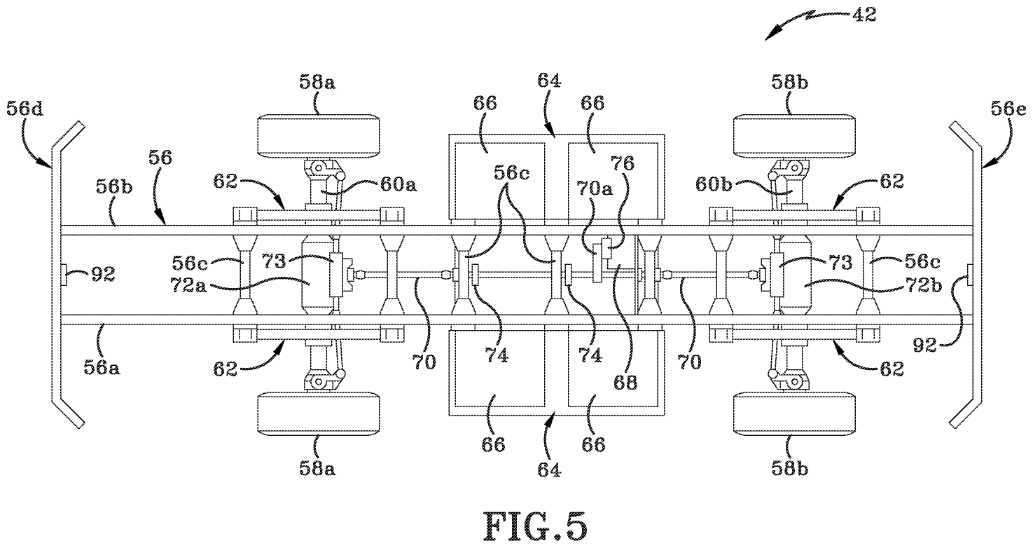

A platform 64 is positioned below support beams 56a, 56b in a location between the pair of front wheels 58a and the pair of rear wheels 58b. A plurality of batteries 66 are located on an upper surface of platform 64 and are removably locked into place thereon. The figures show four batteries 66 are positioned on platform 64 but it will be understood that only a single battery may be provided on platform 64 or two, three, or more than four batteries 66 may be utilized on vehicle 16. As best seen in FIG. 5, batteries 66 are located on platform 64 such that two batteries 66 are located on a left hand side of first longitudinal support beam 56a and two batteries 66 are located on a right hand side of second longitudinal support beam 56b. As a consequence, a gap is defined between the left hand side batteries and the right hand side batteries. A motor 68 is provided in the gap between the left hand side batteries 66 and right hand side batteries 66, i.e., between an inner surface of first support beam 56a and an inner surface of second support beam 56b. In particular, motor 68 is an electric motor that powers both axles 60a, 60b. While only a single motor 68 is illustrated as being part of vehicle 16, it will be understood that more than one motor 68 may be utilized on vehicle 16. For example, two independent electric motors may be utilized to power the two axles 60a, 60b, with one electric motor powering the front axle 60a and the second electric motor powering rear axle 60b. These independent electric motors can be mounted on the chassis and utilize a drive shaft to connect them to the axles or can be of an integral design mounted directly on the axles. It should be understood that the axle configuration on vehicle 16 may be of any other combination of axle configurations, for example 2 WD fixed rear axle and standard front steer, front wheel drive fixed rear axle, etc.

A drive shaft 70 (FIG. 5) is operatively engaged with motor 68 and thereby with batteries 66 via a drive belt 70a. Drive shaft 70 is operatively engaged with axles 60a and 60b via differentials 72a, 72b and is actuated to rotate axles 60a, 60b and to thereby rotate wheels 58a, 58b. As illustrated, vehicle 16 includes a 4-wheel drive and 4-wheel steering system that ensures good traction with the surface “S” over which vehicle 16 travels. The 4-wheel steering system helps to ensure that vehicle is capable of making tight turns at the end of narrow feed alleys, such as feed alley 36. Bearing blocks 74 are provided at intervals along drive shaft 70 to help ensure drive shaft 70 rotates properly. An electrical hookup 76 is operatively engaged with motor 68 and with various components provided on vehicle 16, as will be later described herein.

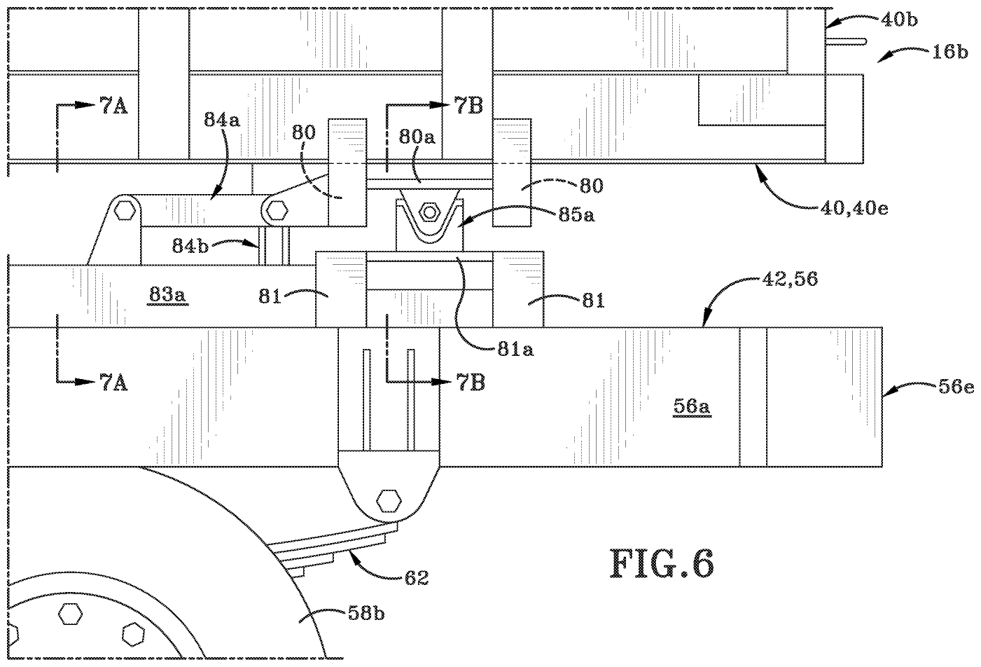

Referring to FIGS. 6-8, pairs of transversely-extending beams 80 are provided at longitudinally spaced-apart intervals along bottom wall 40e of feed delivery box 40. A horizontally-oriented plate 80a extends between the beams 80 of each pair of beams 80. Pairs of transversely-extending beams 81 are provided at longitudinally spaced-apart intervals along the upper surface of frame 56. Beams 81 are engaged with laterally spaced apart longitudinal beams 83a, 83b that are located adjacent an upper surface of frame 56. A horizontally oriented plate 81a extends between the beams 81 of each pair of beams 81. The beams 80 and 81 are generally vertically aligned with each other as can be seen in FIG. 6. Beams 80 are secured to feed delivery box 40 by any suitable means such as by welding. Similarly, beams 81, 83a, 83b are secured to frame 56 by any suitable means such as by welding.

A weight sensor 82 is operably engaged with each set of plates 80a, 81a. Weight sensors 82 are part of a scale assembly that is interposed between delivery box 40 and chassis 42 and is operably linked to a control assembly. (The control assembly comprises main control box 86 and may also include an electric relay 88.) The scale assembly substantially continuously weighs delivery box 40 and the load of feed 24 carried therein and a speed of vehicle 16 across the surface and along the pathway 20 is correlated with a combined weight of the delivery box 40 and the load of feed 24 so an exact weight of feed is delivered to feed bunk 34 per linear foot traveled by vehicle 16. A plurality of longitudinally aligned linkages 84a and laterally aligned linkages 84b extend between beams 83a, 83b and 80. A plurality of connectors 85a, 85b extend between the plates 80a, 81a of each set of plates. The plate members of each connector 85a are generally longitudinally aligned and the plate members of each connector 85b are generally transversely aligned. A bolt (not numbered) is received through slots defined in the plate members of each connector 85a, 85b. The plate members are able to move very slightly vertically relative to each other. The linkages 84a, 84b are configured so that the also allow very slight vertical movement between chassis 42 and feed delivery box 40. Linkages 84a, 84b are also useful in restraining lateral movement of feed delivery box 40 relative to chassis 42. The configuration of the feed delivery box 40, chassis 42, beams 80, 83a, 83b, and sensor assemblies (made up of each group of a sensor 82 extending between opposed plates 80a, 81a, allows feed delivery box 40 to “float” relative to chassis 42, i.e., move slightly upwardly or downwardly, slightly forwardly or rearwardly, or slightly to the left or right. This configuration is helpful because it allows for relative movement between feed delivery box 40 and chassis 42 when feed is loaded into chamber 40f and are removed therefrom through door 40g.

As the overall weight of feed 24 in chamber 40f is increased, the weight sensors 82 will register this change in weight and relay that information to the control assembly. Similarly, as the overall weight of feed 24 in chamber 40f is decreased, the weight sensors 82 will register this decrease in weight and relay that information to the main control box 86. The scale assembly substantially continuously weighs the delivery box 40 and the load 24 carried therein and substantially continuously relays that information to the main control box 86. The programming in main control box 86 is configured to adjust the speed of vehicle 16 along pathway based on the overall weight of vehicle 16. The speed of the autonomous vehicle 16 is therefore correlated with the combined weight of the delivery box 40 and the load 24. Alternatively, the vehicle 16 may have a substantially constant ground speed and the flow of feed coming out of delivery box 40 may be modulated accordingly.

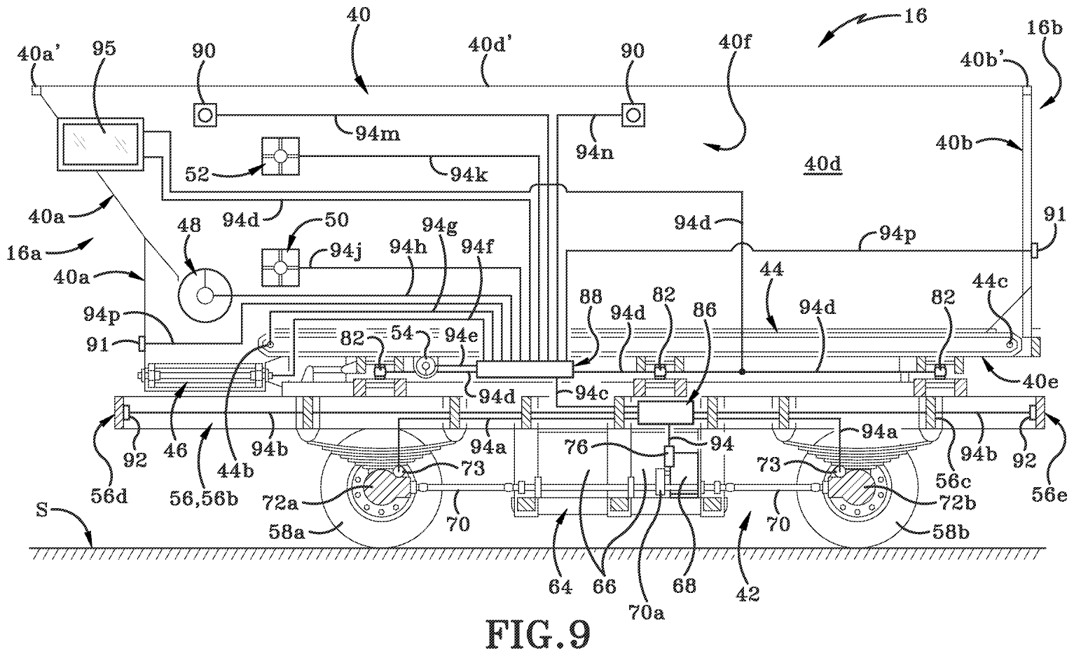

Main control box 86 (FIG. 9) autonomously controls all functions of vehicle 16. Main control box 86 includes one or more processors uploaded with programming configured to autonomously control all equipment on and functions of vehicle 16. The programming includes automated feed distribution algorithms that determine desired quantity of mixed feed to be delivered to a particular length of feed bunk 34. The feed distribution algorithms help to insure precise and uniform feed delivery to feed bunk 34 and therefore to cattle 32. The algorithms calculate and control the ground speed at which vehicle 16 moves. This ground speed is driven by feedback signals from the onboard weight scales 82. The programming also includes maps of feedlot 14, feed alleys 36, feed bunks 34, mixers 22, pathways 20 to follow, feeding times and frequencies, feed combinations and desired rates of delivery, and any and all other relevant information used to determine and control feeding of the cattle 32 in feedlot 14. The programming also includes algorithms for gathering and utilizing information provided by monitoring information collected by various cameras 90, lasers 91, and sensors 92. Information may also be gathered and transferred to controller 18 or main control box 86 from various locations around feedlot 14, mixer 22, conveyor 26, loading station 28, and feed bunk 34 or in the vicinity of vehicle 16. Appropriate timers may be provided in main control box 86 to automatically activate motor 68 and all other systems on vehicle 16 at predetermined times stored in a database in the processor of main control box 86. Alternatively, timers and programming in controller 18 may automatically activate main control box 86 to start motor 68. Alternatively, a human operator may activate controller 18 to actuate main control box 86. Vehicle 16 and its operation may, from time to time, be monitored or evaluated by a human operator. Programming in main control box 86 may automatically shut off any, some, or all components of load-advancement mechanism if needful. For example, if feed become jammed in primary conveyor 44, the processor may shut off primary conveyor 44 or the primary and secondary conveyor 46. Similarly, the programming may automatically shut off the load-delivery assembly or any, some, or all components thereof. Still further, if an obstruction suddenly appears in front of vehicle 16, for example, if a human or cow walks in front of vehicle 16, the programming will shut off vehicle 16 and prevent further movement thereof along pathway until the obstruction is cleared. Main control box 86 may communicate with controller 18 to alert human operators that an issue has arisen that needs human intervention.

It will be understood that not all of the components present on feed delivery box 40 and/or on chassis 42 are illustrated in the attached figures or are described herein. For example, brakes (not shown) will be provided on chassis 42 to enable the vehicle to slow down or stop during performance of a feeding operation or in the event of an emergency. The brakes will be operatively engaged with and controlled by the main control box 86 and electrical relay 88. In particular, chassis 42 will be provided with both service brakes and an emergency brake. Other components provided on feed delivery box 40 or chassis 42 are illustrated in the attached figures but are not discussed herein as they will be obvious to those of ordinary skill in the art to include them on the chassis 42 or feed delivery box 40 to enable the vehicle and systems to function.

FIG. 9, shows some of the electrical connections between various components on vehicle 16. It will be understood that the illustrated electrical connections are by way of example only. Other electrical connections may be present in vehicle 16 but not illustrated in the attached figures. Vehicle 16 is provided with a main control box 86 that is mounted on frame 56 and is operatively engaged with motor 68 via electrical hookup 76. An electrical relay 88 is provided on feed delivery box 40. A plurality of onboard cameras 90, lasers 91 and/or other sensors 92 are provided in various locations on feed delivery box 40 and chassis 42. The onboard cameras 90 lasers 91, and sensors 92, all for viewing and recording of all operations of vehicle 16, including feed delivery. Main control box 86 utilizing onboard data recording of all equipment operations parameters. These operation parameters include battery management. For example, one or more cameras 90 are provided on left side wall 40c and right side wall 40d of feed delivery box 40 to provide images to an operator of how feed is moving through chamber 40f. Lasers 91 or other types of sensors are provided on front and rear bumpers 56d, 56e of chassis 42 and on front wall 40a and rear wall 40b of feed delivery box 40. The sensors 92 on front and rear bumpers 56d, 56e ensure that each bumper is an impact-sensing bumper that will cause motor 68 to immediately shut off, should the front or rear bumper 56d, 56e contact any type of obstacle. Onboard safety and sensing instrumentation helps to ensure that no human-to-machine, animal-to-machine, or obstacle-to-machine incidents occur that could cause injury to persons or animals or damage to obstacles in the feedlot 14 and surrounding areas through which vehicle 16 travels. The programming provided in main control box 86 may also be configured to detect people and obstacles a preset distance in front of vehicle 16 using lasers 91 and/or cameras 90 provided on various external surfaces of the feed delivery box 40 or chassis 42. If a person or obstacle is detected by the lasers 91 and/or cameras, motor 68 will immediately shut off and forward motion of vehicle 16 will cease. When the person or obstacle moves, the main control box 86 will automatically restart motor 68 and continue the mission moving vehicle 16 along pathway 20, delivering feed to feed bunk 34, or being reloaded at mixing station 22. Cameras 90, lasers and sensors 92 may be provided on vehicle 16 to monitor any desired aspect of vehicle 16 and its operation.

FIG. 9 shows exemplary wiring that connects various electrically operable components of vehicle 16 to main control box 86 and electrical relay 88. It will be understood that not all wiring that is present on vehicle 16 and chassis 42 is illustrated herein. Wiring 94 extends between electrical hookup 76 on motor 68 and control box 86. Wiring 94a operatively links steering mechanisms 73 operably engaged with the axles, differentials 72a, 72b, and leaf spring suspension 62, to main control box 86. Wiring 94b operatively links sensors 92 on front and rear bumpers 56d, 56e to main control box 86. Wiring 94c operatively links electrical relay 88 to main control box 86. Weight sensors 82 go through a scale head 95 before going to electrical relay 88. Wiring 94d operatively links weight sensors 82, scale head 95, and electrical relay 88.

In one embodiment, wiring 94e may operatively link secondary auger 54 to electrical relay 88 and wiring 94f may operatively link secondary conveyor 46 with electrical relay 88. Wiring 94g operatively links front pivot 44b of primary conveyor 44 to electrical relay 88. Wiring 94h operatively links primary auger 48 with electrical relay 88. Wiring 94j and 94k operatively links lower and upper finger rollers 52, 50, respectively, to electrical relay 88. Wiring 94m, 94n operatively links cameras 90 to electrical relay 88. Wiring 94p operatively links lasers 91 on front and rear walls 40a, 40b to electrical relay 88. Since electrical relay 88 is operatively engaged with main control box 86, the wiring 94d-94p operatively engages all of the various components named above to main control box 86. Main control box 86 is provided with programming that is configured to control all of the various components of vehicle 16 in such a way that vehicle 16 is able to drive itself from mixing station 22 along the pathway 20 that includes feed alley 36 and back to mixing station 22. Furthermore, the programming within main control box 86 actuates and controls primary and secondary conveyors 44, 46, auger 48, and finger rollers 50, 52 so as to move feed loaded into chamber 40f at mixing station 22 forwardly within chamber 40f and towards door 40g. The programming within main control box 86 actuates and controls door 40g and raises door 40g to a sufficient degree to enable feed to be moved by secondary conveyor 46 onto chute 40j and thereby to be dropped into feed bunk 34. In accordance with an aspect of the present disclosure, the weight sensors 82 continuously weigh feed delivery box and provide that information to main control box 86. Main control box 86 is provided with automated feed distribution algorithms that control the speed of movement of vehicle 16 along surface “S” based on the weight of the feed remaining in the chamber 40f relative to the desired quantity of feed to be delivered to a particular length of feed bunk 34. The feed distribution algorithms help to insure precise and uniform feed delivery to feed bunk 34 and therefore to cattle 32. The vehicle ground speed is driven by feedback signals from the onboard weight scales 82.

Programming within main control box 86 includes an automated feed distribution algorithm that controls a ground speed of the autonomous vehicle 16 so that an exact weight of feed 34 is delivery per linear foot traveled by the autonomous vehicle 16. Programming within main control box 86 includes an automated feed distribution algorithm that determines and controls a precise amount of mixed feed to deliver from the autonomous vehicle 16 to the feed bunk 34 in the feedlot. Programming within main control box 86 also raises door 40g to a sufficient degree that ensures the desired quantity of feed is delivered down chute 40j and into feed bunk 34 as vehicle 16 moves alongside feed bunk 34 at any particular speed.

In accordance with an aspect of the present disclosure, controller 18 is provided as part of system 10. Controller 18 comprises any type of electronic computing device that may be provided with programming to control all of the component parts of vehicle 16 and to control the operation of vehicle 16. Controller 18 may, additionally control mixer 22, the conveyor 26, and loading station 26. Controller 18 may be located remote from vehicle 16 and for the most part may simply be a monitoring station or a monitoring and recording station. Controller 18 for example, may be master feed process/delivery management system provided on a computing device such as a laptop computer or desktop computer, or on a handheld computing device such as a smartphone. Controller 18 may be actively monitored by a human operator or periodically monitored by a human operator. Communication between a master feed process/delivery management system at the remote location and one or more vehicle 16smay occur through controller 18. In particular, controller 18 is able to be placed in wireless communication with main control box 86 of vehicle 16. Controller 18 and main control box 86 (or any other part of vehicle that is suitable) may include transceivers (not shown) that allow for wireless communication between vehicle 16 and controller 18. Controller 18 is provided with encrypted software that is specifically configured for operating vehicle 16 in the manner disclosed herein. Furthermore, control logic is provided between the various components of the autonomous feeding system 10. The master feed process/delivery management system, for example, activates the station mixer's batching process, turns the station mixer 22 on and off, opens/closes the station mixer door, monitors the load station mixer's cells to know when mixer has off load, etc. Additionally, the control logic turns the off-loading conveyor 26 on and off.

Vehicle 16 is guided by controller 18 along path 20 (FIG. 1). Vehicle 16 operates autonomously on either a preset path (along various feed alleys, such as along feed alley 36), or for a preset distance, guided by GPS (Global Positioning System), and/or 3-point triangulation, laser guidance, a pre-selected path that is programmed and saved in the controller memory, or any other means of guidance. It will be understood that any other apparatus or any other suitable method of guiding vehicle 16 may be employed.

During use of system 10, as shown in FIG. 1, a plurality of different feed is loaded into and mixed by mixer 22 to produce a mixed feed 24. The feed 24 travels along conveyor belt 26 as indicated by the arrow “E”, and into the loading station 28. Controller 18 actuates an autonomous delivery vehicle 16 wirelessly to move into position beneath the loading station 28 and a preset quantity of mixed feed 24 is then loaded into chamber 40fof vehicle 16. The programming in the main control box 86 (FIG. 8) of vehicle 16 actuates motor 68 and thereby causes power to be delivered to main drive shaft 70, axles 60a and 60b and vehicle 16 begins to roll over the surface “S”. Programming uploaded into a processor of main control box 86 or in controller 18 and accessed wirelessly by programming in main control box 86 causes vehicle 16 to begin to follow pathway 20 as vehicle 16 moves in the direction “F” (FIG. 1). Vehicle 16 autonomously moves from mixing station 22 along pathway 20 and enters feed alley 36 alongside feed bunk 34. At a preset time along pathway 20, the drive mechanism 40h on door 40g will cause door 40g to be raised to a predetermined height, thereby creating an opening of a predetermined size in left side wall. As vehicle 16 autonomously moves along pathway 20, primary conveyor 44, secondary conveyor 46, and auger 48, and finger rollers 50, 52 are activated to move a quantity of mixed feed 24 forwardly toward front wall 40a and subsequently toward left side wall 40c and the opening created by the lifting of door 40g. Secondary conveyor 54 and door 40g are actuated at substantially the same time.

The speed of vehicle 16 as it travels along pathway 20 will be controlled by the programming in the processor of main control box 86 or by controller 18. In particular, the speed of vehicle 16 as it travels alongside feed bunk 34 will be controlled so that a predetermined number of pounds per linear foot of feed 24 will drop down the primary chute 40j and into feed bunk 34. If the mixed feed 24 is a more densely packed and heavier, the vehicle 16 will tend to move faster alongside feed bunk 34 than if the mixed feed 24 is a little lighter or less densely packed. As indicated earlier herein, main control box 86 is provided with automated feed distribution algorithms that control the speed of movement of vehicle 16 along surface “S” and particularly along feed alley 36 based on the weight of the feed 24 remaining in the chamber 40f relative to the desired quantity of feed 24 to be delivered to a particular length of feed bunk 34.

In one aspect, an exemplary embodiment of the present disclosure provides an autonomous vehicle 16 for transporting and delivering a load comprising a chassis 42 having wheels 58a, 58b; a delivery box 40 operably engaged with the chassis 42; said delivery box 40 being adapted to carry the load 24 (FIG. 1); a load-dispensing assembly 40g, 40h, 40j, 40m, 54, 40k provided on the delivery box; a load-advancement mechanism 44, 46, 48, 50, 52 provided on the delivery box 40; said load-advancement mechanism 44, 46, 48, 50, 52 being adapted to move the load 24 toward the load-dispensing assembly 40g, 40h, 40j, 40m, 54, 40k; a control assembly 86; and programming provided in the control assembly 86, said programming configured to autonomously control movement of the chassis 42 and delivery box 40 along a predetermined pathway 20, 36; said programming further configured to autonomously control the load-advancement mechanism 44, 46, 48, 50, 52 and load-dispensing assembly 40g, 40h, 40j, 40m, 54, 40k to deliver the load 24 from the delivery box 40 at a preset location 34 along the pathway 20, 36.

Vehicle 16 includes a 4-wheel drive and 4-wheel steering system provided on the chassis 42 that is operably linked to the control assembly 86. Vehicle 16 may further include one or more cameras 90, lasers 91, and sensors 92 provided on one or both of the delivery box 40 and chassis 42, said one or more cameras 90, lasers 91, and sensors 92 being operably linked to the control assembly 86 and providing data to the control assembly 86 to control equipment onboard vehicle 16. Main control box 86 may further include recording equipment that gathers and records concerning operation of all equipment on the vehicle 16 and of the vehicle 16 itself. Vehicle 16 further includes vehicle stability control provided on the chassis to prevent roll-over when the autonomous vehicle is performing turning maneuvers. The stability control systems may include the leaf spring suspension 62, 4-wheel drive, and 4-wheel steering system 73 that ensures good traction with the surface “S” over which vehicle 16 travels. The stability control may also be considered to include the linkages 84a, 84b that control side-to-side motion of feed delivery box 40 relative to chassis 42.

In another aspect, an exemplary embodiment of the present disclosure provide in combination; a load of livestock feed 24; and an autonomous vehicle 16 for transporting and delivering the load of livestock feed 24 to a feed bunk 34 in a feedlot 14 without operator intervention; wherein the autonomous vehicle 16 comprises a chassis 42 having wheels 58a, 58b; a delivery box 40 operably engaged with the chassis 42; said delivery box 40 defining a chamber 40f, wherein the load of livestock feed 24 is carried in the chamber 40f; a load-dispensing assembly 40g, 40h, 40j, 40m, 54, 40k provided on the delivery box 40; a load-advancement mechanism 44, 46, 48, 50, 52 provided on the delivery box 40; said load-advancement mechanism 44, 46, 48, 50, 52 being actuated to move the livestock feed 24 toward the load-dispensing assembly 40g, 40h, 40j, 40m, 54, 40k; a control assembly 86; and programming provided in the control assembly 86, said programming configured to autonomously control movement of the chassis 42 and delivery box 40 along a predetermined pathway 20, 36 in the feedlot 14; said programming further configured to autonomously control the load-advancement mechanism 44, 46, 48, 50 , 52 and load-dispensing assembly 40g, 40h, 40j, 40m, 54, 40k to deliver the livestock feed 24 from the delivery box 40 and into a feed bunk 34 at a preset location along the pathway 20, 36.

In another aspect, an exemplary embodiment of the present disclosure provides a method of delivering feed 24 to livestock 32 comprising loading livestock feed 24 into a chamber 40f defined by a delivery box 40 of an autonomous vehicle 16; actuating a control assembly 86 on the autonomous vehicle; actuating a motor 68 on the autonomous vehicle 16 with programming provided in the control assembly 86; moving the autonomous vehicle 16 along a pathway 20, 36 programmed into the control assembly 86; actuating a load-advancement mechanism 44, 46, 48, 50, 52 provided in the delivery box 40 with the programming of the control assembly 86; advancing the livestock feed 24 towards a load-delivery assembly 40g, 40h, 40j, 40m, 54, 40k provided on the delivery box 40; actuating the load-delivery assembly 40g, 40h, 40j, 40m, 54, 40k with the programming provided in the control box 86; and delivering the livestock feed 24 from the chamber 40f to a location 34, for example, outside of the delivery box chamber 40f. In one embodiment at least the steps of actuating the motor 68 through to delivering the livestock feed 24 are accomplished independent of human interaction with the autonomous vehicle 16.

The method further comprises substantially continuously weighing the delivery box 40 and the livestock feed 24 therein using a scale assembly 82 operatively engaged with the control assembly 86 and interposed between the delivery box 40 and chassis 42. The method further comprises adjusting, with the control assembly 86, a speed of the autonomous vehicle 16 along the pathway 20, 36 based on the weight of the delivery box 40 and the livestock feed 24 therein and as measured by the scale assembly 82. The adjusting of the speed of the autonomous vehicle 16 is controlled utilizing automated feed distribution algorithms programmed into the control assembly 86. The delivery of the livestock feed 24 includes determining a precise amount of mixed feed (or unmixed feed) 24 to deliver to the feed bunk 34 using the automated feed distribution algorithms programmed into the control assembly 86.

In the method, delivering of the livestock feed 24 includes controlling the feed flow rate by either speeding up or slowing down the ground speed of vehicle 16. By varying of the ground speed of vehicle, 16, a uniform output of feed 24 to the livestock is able to be accomplished/controlled via an algorithm by the changing weight of feed 24 remaining in the feed delivery box 40. In the method, the door 40g is moved to a fully opened position and the vehicle's speed will be modulated (i.e., speeded up or slowed down) so that a precise weight per distance, i.e., pounds per linear foot, of livestock feed 24 is off-loaded from the vehicle 16 through the complete off-loading process. The automated off-loading of vehicle 16 utilizes the changing scale's weight values as a feedback mechanism to control the vehicle's ground speed. By delivering livestock feed 24 in this automated manner, the vehicle 16 is able to off-load the feed more rapidly and therefore the utilization of the equipment is greatly enhanced.

In other embodiments, the method, the delivering of the livestock feed 24 may include adjusting a size of an opening (that is selectively covered by door 40g) in a side wall 40c of the delivery box 40 to a predetermined size based on the automated feed distribution algorithms and a nature of the livestock feed 24 being moved through the opening by the load-delivery assembly 40g, 40h, 40j.

In the method, the loading of the livestock feed 24 into the autonomous vehicle 16 includes moving the autonomous vehicle 16 to a location adjacent a feed mixer 22; and depositing a quantity of mixed feed 24 from the feed mixer 22 into the chamber 40f of delivery box 40.

The method further comprises returning the autonomous vehicle 16 to the feed mixer 22 after delivering all of the mixed feed 24 into the feed bunk 34; and placing another load of mixed feed 24 into the delivery box 40 of the autonomous vehicle 16. The method further comprises monitoring all operations of the autonomous vehicle 16 using programming provided in the control assembly 86. The method further comprising actuating, with the control assembly 86, one or more cameras 90, lasers 91, and sensors 92 provided on one or both of the delivery box 40 and the chassis 42; monitoring all the operations of the autonomous vehicle 16 using the one or more cameras 90, lasers 91, and sensors 92; and recording, with the control assembly 86, all the operations of the autonomous vehicle 16.

While vehicle 16 has been discussed herein as being an autonomous guided feed delivery system that delivers feed to livestock without any operator interaction, in other instances, an onboard operator may be utilized to control vehicle 16 if needed.

It will be understood that while vehicle 16 is disclosed herein as being an electric vehicle powered by one or more batteries 66, other ways of powering vehicle 16 may be utilized in other embodiments. For example, solar power may be utilized on vehicle 16 or vehicle 16 may be a hybrid vehicle powered partially by fossil fuels, partially by electricity, and/or fully by fossil fuels. Batteries 66 may be rechargeable batteries.

It will be further understood that while vehicle 16 has been described herein as being useful for delivering feed to cattle and other livestock, vehicle 16 may be utilized for other purposes simply by changing the equipment that is engaged with chassis 42.

While vehicle 16 has been described herein as having wheels 58a, 58b, engaged on chassis 42, it will be understood that vehicle 16 may be provided with any other suitable type of translation assembly or translation mechanism that will enable vehicle 16 to move across a surface. For example, instead of wheels 58a, 58b, chassis 42 may include endless tracks. In other embodiments, the vehicle 16 may be contemplated to move along a track and in this instance, the translation assembly may take the form of bogeys that are engaged with chassis 42. In yet other embodiments, if it is contemplated that vehicle 16 will be utilized in cold, snowy climates, vehicle 16 may be provided with runners.

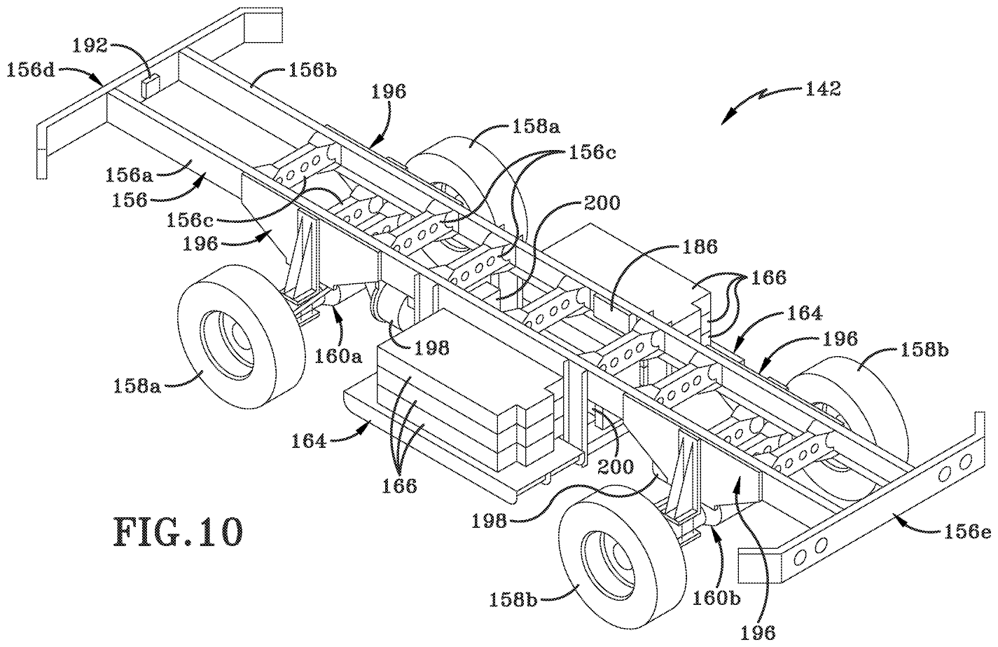

Referring now to FIGS. 10 through 12, there is shown a second embodiment of a chassis in accordance with an aspect of the present disclosure, generally indicated at 142. Chassis 142 includes many of the same features as chassis 42 but differs in regard to several components that will be pointed out hereafter. Feed delivery box 40 will be engaged with chassis 142 in a substantially similar manner to the manner in which feed delivery box 40 is engaged with chassis 42. Chassis 142 will perform substantially the same function as chassis 42.

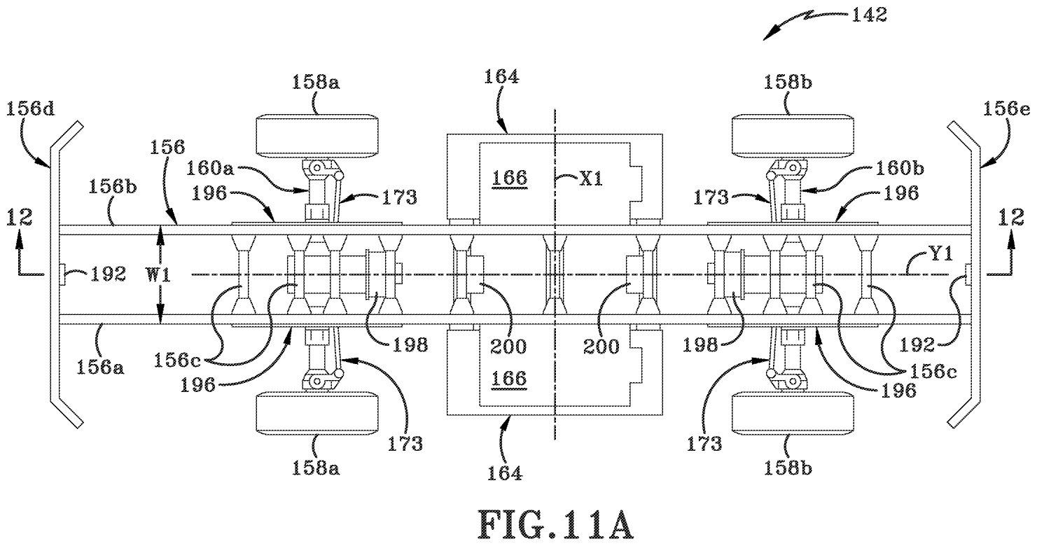

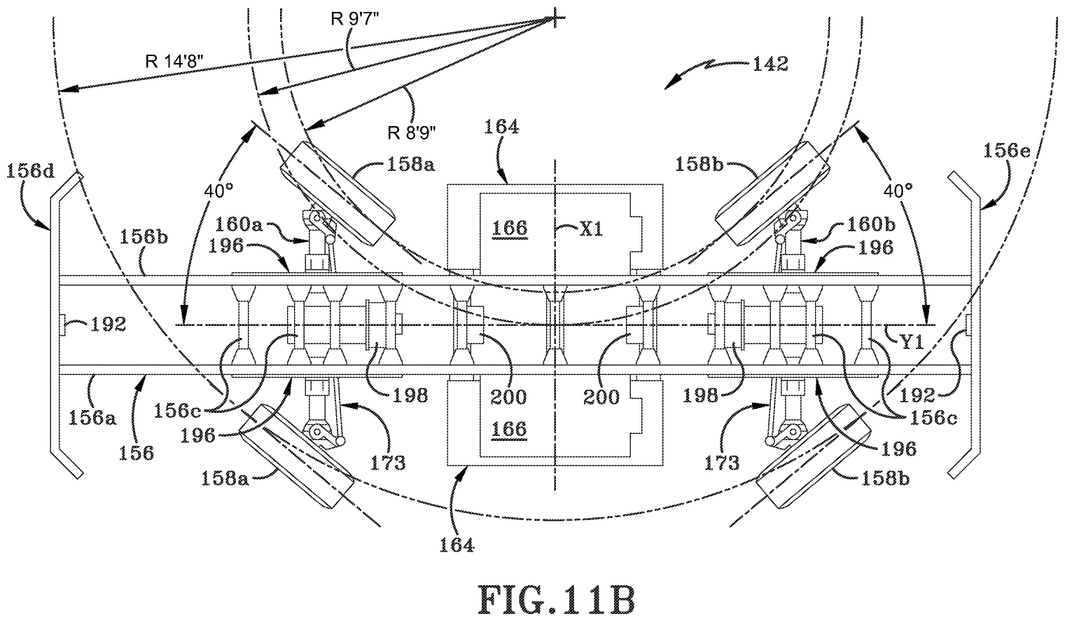

Chassis 142 comprises a frame 156 having at least a pair of laterally spaced apart support beams 156a, 156b, and a plurality of longitudinally spaced-apart crossbeams 156c. Support beams 156a, 156b are oriented substantially parallel to a longitudinal axis “Y1” (FIG. 11A) and crossbeams 156c are oriented transversely relative to axis “Y1”. Frame 156 includes a front bumper 156d and a rear bumper 156e that are operatively engaged with support beams 156a, 156b and are oriented transversely relative thereto. It will be understood that beams 156a, 156b may be of any suitable desired length and crossbeams 156c may be of any suitable desired width. In one embodiment, the outside width “W1” (FIG. 11A) of support beams 156a and 156b is thirty-four inches, which is the same width as the frame of a commercial truck. As with chassis 42, the various component parts of frame 156 of chassis 142 are preferably joined together by any suitable means such as HUCK® fasteners and/or welding.

As shown in FIG. 11A, a pair of front wheels 158a and a pair of rear wheels 158b are illustrated as being operatively engaged with support beams 156a, 156b of frame 156 via a front axle 160a and a rear axle 160b. In one embodiment, the axles 160a, 160b are fitted with 13,000 lb., load rated tires/wheels. In one embodiment, suitable axles 160a, 160b for use in chassis 142 and are equipped with hydraulically activated wet disc brakes (not shown). One of the differences between chassis 142 and chassis 42 is that instead of the leaf spring suspensions 62 of chassis 42, chassis 142 includes rigid axle mount assemblies 196 that are operatively engaged with support beams 156a, 156b, and crossbeams 156c and are used to rigidly mount axles 160a, 160b to the frame. The rigid axle mount assemblies 196 provide vehicle stability. It will be understood that if the frame 156 is of a longer length than illustrated, at least one additional pair of wheels may be engaged with frame 156 via an associated axle and associated rigid axle mount assemblies.

It will be understood that frame 156 may include other component parts in addition to support beams 156a, 156b, and crossbeams 156c that are not illustrated or are not discussed further herein. FIG. 11A shows that chassis 142 is substantially symmetrical about a longitudinal axis “Y1” and about a transverse axis “X”. Support beams 156a, 156b may extend a short distance further outwardly beyond the front axle 160a than the distance tow which support beams 156a, 156b extend rearwardly beyond the rear axle 160b in order to accommodate the asymmetrical design of the feed delivery box 40. The symmetry of chassis 142 offers commonality of parts from a manufacturing point of view and is therefore less expensive to fabricate. Additionally, the symmetry of chassis 142 enables the vehicle to be used as a push-pull system that is capable of moving in a forward direction and a reverse or rearward direction with equal ease.

A further difference between chassis 42 and chassis 142 is that a separate electric motor 198 (FIG. 11A) is integral with each of the front axle 160a and rear axle 160b. Each motor 198 is preferably a heavy duty/high torque electric traction motor that is mounted to the associated axle. The axle input of each axle 160a, 160b is powered via the associated electric motor 198.

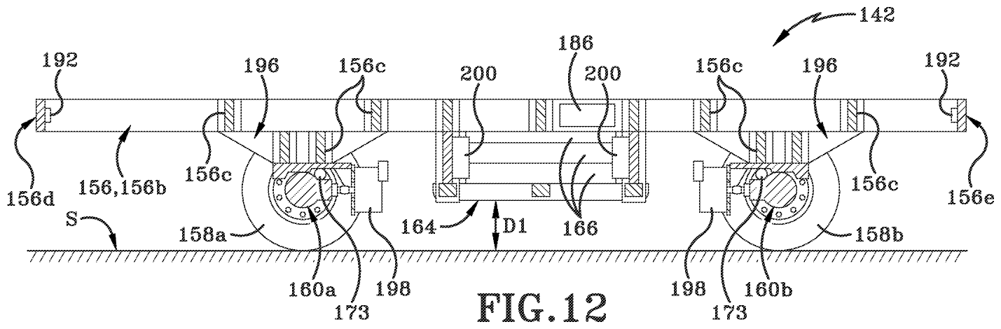

A platform 164 is mounted to support beams 156a, 156b in a location below the support beams 156a, 156b and between the pairs of front wheels 158a and rear wheels 158b. A bottom of platform 164 is located at a ground clearance distance “D1” (FIG. 12) of about twenty inches away from the surface “S” over which the chassis 142 travels. Platform 164 comprises a first platform section that extends laterally outwardly for a distance beyond support beam 156a in a first direction and a second platform section that extends laterally outwardly for a distance beyond support beam, 156b. Platform 164 does not extend outwardly beyond the wheels 158a, 158b and is symmetrical with respect to the longitudinal axis “Y1”.

A plurality of batteries 166 is located on an upper surface of each of the first and second platform sections of platform 164 and the batteries are operatively secured thereto. The figures show three batteries 166 are positioned on the platform sections on either side of the support beams 156a, 156b. A gap is defined between the two battery stacks. It will be understood that in other embodiments, a single battery 166 or two batteries 166 may be provided on each side of platform 164. In other embodiments, more than four batteries 166 may be provided on each side of the platform 164. The location and weight of batteries 166 provides a low center of gravity to the vehicle and this enhances overall stability of the vehicle. Although not illustrated herein, it should be understood that the central area (i.e., the gap) between the two battery stacks will house hydraulic pump power pack components that will be utilized to power hydraulic motors on the feed delivery box 40.

Two motor controllers 200 (FIGS. 11A, 12) are operatively engaged on chassis 142 in a location between the two stacks of batteries 166. The motor controllers 200 may be secured to crossbeams 156c or to platform 164. In other instances, motor controllers 200 may additionally or alternatively be mounted on support beams 156a, 156b. Preferably the motor controllers 200 are mounted so that symmetry of the chassis 142 is maintained. Each motor controller 200 is operatively engaged with one of the two motors 198 provided on the front axle 160a or rear axle 160b. The motor controllers 200 are operatively engaged with the electrical relay 88 on feed delivery box 40. A main control box 186 and sensors 192 similar to main control box 86 and sensors 192 are provided on chassis 142. Motor controllers 200 are operatively engaged with main control box 186. Main control box 186 configured to function in a manner similar to main control box 86.

Chassis 142 includes a 4-wheel drive and 4-wheel steering system that ensures good traction with the surface “S” over which the autonomous vehicle travels. The 4-wheel steering system helps to ensure that vehicle is capable of making tight turns at the end of narrow feed alleys, such as feed alley 36. Steering is accomplished via a steering mechanism 173 mounted on the front and rear axles 160a, 160b. Steering mechanism 173 includes hydraulic cylinders. FIG. 11B illustrates an exemplary tight turn that is possible with the 4-wheel drive and 4-wheel steering system of chassis 142 and shows the possible radii of curvature and angles through which the wheels 158a, 158b may travel. In one embodiment, rear axle 160b is configured to be locked during straight travel of the vehicle.

The vehicle 16 that includes either of the first embodiment chassis 42 or second embodiment chassis 142 may be programmed to travel at a maximum speed of about 20 mph, and is supported by two axles 60a, 60b or 160a, 160b that are loaded to 12 tons per axle (i.e., 24,000 lbs.), has 4-wheel drive and 4-wheel steering capability, and is capable of a total laden load of 50,000 lbs. The bolt center on the axle hub is 275 mm with 8-22 mm diameter lug bolts. The hub pilot bore is 220.6 mm in diameter. Each wheel 58a, 58b, or 158a, 158b preferably is a wide profile off road drive style tire with the outside diameter in the order of 46 to 50 inches.

It will be understood that chassis 142 is operatively engaged with feed delivery box 40 in substantially the same manner as chassis 42 and that chassis 142 performs substantially the same functions as chassis 42 in a substantially similar manner.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or other electronic device utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or electronic devices may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks. Encrypted software is provided for operating the presently disclosed vehicle and system.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, Cloud based, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first”, “second”, “ primary”, and “secondary” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An autonomous vehicle for transporting and delivering a load comprising:
a chassis having a translation assembly adapted to move the chassis across a surface;
a delivery box operably engaged with the chassis; said delivery box being adapted to carry the load;
a load-dispensing assembly provided on the delivery box;
a load-advancement mechanism provided on the delivery box; said load-advancement mechanism being adapted to move the load toward the load-dispensing assembly;
a control assembly;
programming provided in the control assembly, said programming configured to autonomously control movement of the chassis and the delivery box along a predetermined pathway; said programming further configured to autonomously control the load-advancement mechanism and the load-dispensing assembly to deliver the load from the delivery box at a preset location along the pathway.

2. The autonomous vehicle according to claim 1, wherein the programming is further configured to autonomously deliver the load from the delivery box at a substantially uniform flow rate.

3. The autonomous vehicle according to claim 1, wherein the programming is further configured to control a ground speed of the autonomous vehicle as the autonomous vehicle travels along the pathway.

4. The autonomous vehicle according to claim 3, wherein the programming is further configured to dispense the load from the delivery box at a substantially uniform flow rate that is correlated to the ground speed.

5. The autonomous vehicle according to claim 1, further comprising:
a scale assembly interposed between the delivery box and the chassis and operably linked to the control assembly; wherein the scale assembly substantially continuously weighs the delivery box and the load carried therein.

6. The autonomous vehicle according to claim 5, wherein a ground speed of the autonomous vehicle traveling along the pathway is correlated with a combined weight of the delivery box and the load so that a substantially exact weight of the load is delivered per linear foot traveled by the autonomous vehicle at the preset location.

7. The autonomous vehicle according to claim 1, further comprising one or more batteries provided on the chassis to power the autonomous vehicle.

8. The autonomous vehicle according to claim 1, further including one of more of a camera, a sensor, and a laser operably engaged with the control assembly and configured to gather data about an environment in which the autonomous vehicle operates.

9. The autonomous vehicle according to claim 1, further comprising at least one bumper provided on the chassis.

10. The autonomous vehicle according to claim 1, wherein at least the chassis having the translation assembly, the delivery box, the load-dispensing assembly, and the load-advancement mechanism are provided on a truck.

11. In combination;
a load of livestock feed; and
an autonomous vehicle for transporting and delivering the load of livestock feed to a feed bunk in a feedlot without operator intervention; wherein the autonomous vehicle comprises:
a chassis having a translation assembly adapted to move the autonomous vehicle across a surface;
a delivery box operably engaged with the chassis; said delivery box defining a chamber, wherein the load of livestock feed is carried in the chamber;
a load-dispensing assembly provided on the delivery box;
a load-advancement mechanism provided on the delivery box;
said load-advancement mechanism being actuated to move the load of livestock feed toward the load-dispensing assembly;
a control assembly; and
programming provided in the control assembly, said programming configured to autonomously control movement of the chassis and delivery box along a predetermined pathway in the feedlot; said programming further configured to autonomously control the load-advancement mechanism and the load-dispensing assembly to deliver the load of livestock feed from the delivery box and into a feed bunk at a preset location along the pathway.

12. The combination according to claim 11, wherein the programming is further configured to autonomously deliver the load of livestock feed from the delivery box at a substantially uniform flow rate.

13. The combination according to claim 11, wherein the programming is further configured to control a ground speed of the autonomous vehicle as the autonomous vehicle travels along the pathway.

14. The combination according to claim 13, wherein the programming is further configured to dispense the load of livestock feed from the delivery box at a substantially uniform flow rate that is correlated to the ground speed.

15. The combination according to claim 11, wherein the programming includes an automated feed distribution algorithm that determines a precise amount of mixed livestock feed to deliver from the autonomous vehicle to the feed bunk in the feedlot as the load of livestock feed.

16. The combination according to claim 11, wherein the programming includes an automated feed distribution algorithm that controls a ground speed of the autonomous vehicle so that an exact weight of feed is delivered per linear foot traveled by the autonomous vehicle at the preset location.

17. The combination according to claim 11, wherein the autonomous vehicle is a truck.

18. A method of delivering feed to livestock comprising:
loading livestock feed into a chamber defined by a delivery box of an autonomous vehicle;
actuating a control assembly on the autonomous vehicle;
actuating a motor provided on the autonomous vehicle with programming provided in the control assembly;
moving the autonomous vehicle along a pathway programmed into the control assembly;
actuating a load-advancement mechanism provided in the delivery box with the programming of the control assembly;
advancing the livestock feed towards a load-delivery assembly provided on the delivery box;
actuating the load-delivery assembly with the programming provided in the control assembly; and
delivering the livestock feed from the chamber to a location outside of the delivery box chamber.

19. The method according to claim 18, wherein at least the steps of actuating the motor through to delivering the livestock feed is accomplished independent of human interaction with the autonomous vehicle.

20. The method according to claim 18, further comprising, providing at least the delivery box , the motor, the load-advancement mechanism, and the load-delivery assembly on a truck.
